(19) United States
(12) Patent Application Publication
(10) Pub. No.: US 2014/0026531 A1
(43) Pub. Date: Jan. 30, 2014

(54) MOWING VEHICLE

(71) Applicant: matev GMBH, Langenzenn (DE)

(72) Inventors: WILHELM DUERSCHINGER, FUERTH (DE); ERNST DIMMLING, ROSSTAL (DE)

(73) Assignee: matev GMBH, Langenzenn (DE)

(21) Appl. No.: 13/941,864

(22) Filed: Jul. 15, 2013

(30) Foreign Application Priority Data
Jul. 13, 2012 (DE) 102012013983.7

(51) Int. Cl. A01D 43/063

(52) U.S. Cl. CPC A01D 43/0635
USPC 56/13.3

(57) ABSTRACT

A mowing machine, more particularly a front mowing vehicle, has a tractor driven by an internal combustion engine and a grass collecting system as well as with a gear unit which can be coupled to the tractor via a drive shaft and which has a first gear shaft for driving a cutting unit mounted at the front of the vehicle. The grass collecting system has a lift- and tilt cut-grass collecting container mounted at the back of the vehicle, and a turbine for aspirating the cut grass from the cutting unit and conveying the cut grass into the cut-grass collecting container. For driving the turbine a hydraulic oil supply device is provided in an oil circuit including an oil tank. The oil conveying device is coupled by a second gear shaft to the gear unit which is driven by the tractor.

The invention relates to a mowing machine, more particularly a front mowing machine, with a tractor controlled by a driver and with a grass collecting system.

Mowing machines of this kind are often used for mowing large areas of grass, such as by way of example parks or sports fields. A mowing machine of the type mentioned typically comprises a tractor, driven by an internal combustion engine, with a front driver cab and with a rear drive combustion engine as well as a grass collecting system with a cut-grass collecting container at the rear of the vehicle.

The grass collecting system has a cutting unit which is coupled at the front to the grass collecting system. The cutting unit typically comprises a gear unit via which the cutting tool can be coupled to and operated by the drive combustion engine of the tractor. The cutting tool conventionally has one or more mowing beams or cutting blades associated with the cutting unit.

Depending on the design of the grass collecting system the cut-grass collecting container can be supported in practice by the tractor behind the driver seat or driver cab (semi-trailer-variation) or can be towed by the tractor as a trailer with for example one wheel axle with two wheels. The cut-grass collecting container is as a rule assigned a turbine from which a flexible duct in the form of a hose or the like leads to the cutting unit. The cut grass is sucked up from the cutting unit by means of the turbine and passed into the cut-grass collecting container.

The cut-grass collecting container is typically adjustable hydraulically for the purpose of emptying the cut grass into a stand-by transport vehicle. With certain designs the cut-grass collecting container can be lifted up over a loading edge of a stand-by vehicle in order to be able to tip the cut grass out from the cut-grass collecting container.

The turbine is more conventionally likewise hydraulically operated. For this, hydraulic oil is guided by means of a pump as the oil supply device in an oil circuit in which an oil tank is mounted. The oil tank is frequently arranged for the purpose of weight balance on the side of the cut-grass collecting container opposite the turbine—and thus behind the driver cab. During the course of the oil circuit of the hydraulic oil by means of the oil supply device the oil heats up during the operation, whereby the developing heat which arises can also extend to the driver cab so that the user comfort is negatively affected. Typically the oil supply device is mounted close to the oil tank so that it can lead on one hand to overheating of the oil supply device, and on the other side cause additional noise and heat discomfort for the vehicle driver.

The invention is therefore concerned with the problem of providing a mowing machine of the type mentioned at the beginning which whilst avoiding the said drawbacks comprises a structurally simple and cost-effective oil supply device.

This is achieved according to the invention through the features of claim 1. Advantageous designs and further developments form the subject of the dependent claims.

To this end it is proposed that with a mowing machine, more particularly a front mowing machine, with a tractor and with a grass collecting system, the drive motor of the tractor can be coupled by a drive shaft to a first gear shaft of a gear unit, which has a second gear shaft for driving the cutting unit mounted at the front of the vehicle. The cut-grass collecting container which can be lifted and tilted and is mounted at the rear of the vehicle is assigned a turbine for sucking up the cut grass from the cutting unit as well as for conveying the cut grass into the cut-grass collecting container.

A hydraulic oil supply device is provided in an oil circuit comprising an oil tank for driving the turbine. The oil supply device is coupled to the gear unit and is operated through technical driving means with the tractor i.e. with its drive motor. Through the common coupling of the cutting unit and the oil supply device with the gear unit, both apparatuses can be operated substantially at the same time and together by means of the tractor or its drive motor respectively. An additional separate drive for the oil supply device and a separate coupling of the oil supply device to the drive motor are thereby unnecessary. More particularly the noise and/or heat development during operation of the mowing machine are thereby reduced and thus the user comfort is increased.

In a preferred development the gear unit has a substantially cube-like gear housing from which the gear shaft which can be coupled to the drive, and the gear shaft which is coupled to the cutting unit, as well as the gear shaft which can be coupled to the oil supply device project at least in part.

In an advantageous embodiment the three gear shafts project substantially T-shaped and off-set by 90° relative to one another out from the gear housing. The drive shaft of the drive motor is preferably guided on the front end side of the mowing machine and projects there as a shaft journal in the manner of a power take-off coupling. The gear shaft on the side of the cutting unit runs roughly vertically along the short T-arm and projects on the ground side out from the gear housing. The gear shaft on the drive side runs roughly horizontally along the long T-arm and projects on the vehicle side out from the cube-like gear housing. The shaft journal thereby formed and the shaft journal at the front driven by the drive motor are preferably coupled to one another by a universal joint shaft. The cutting unit can be driven by means of the drive motor via this universal joint shaft. The gear shaft (on the pump side) which can be coupled to the oil supply device preferably projects along the short T-arm vertically out from the side face of the gear housing remote from the ground.

The oil supply device which can be designed in the manner of a reciprocating hydraulic pump, is coupled to the gear shaft on the pump side by way of a coupling. In a particularly preferred development the oil supply device is mounted substantially vertically above the gear unit. A common as well as structurally simple and space-saving coupling is thereby produced from the oil supply device and cutting unit to the tractor and its drive motor.

The mowing machine can also be operated without the grass collecting system as well as by way of example with and without a turbine and cut-grass collecting container. More particularly by de-coupling the gear shafts it is possible to rapidly and easily replace the cutting unit with a snow-clearing device, rotating brush elements or a leaf suction device. The functionality of the vehicle is thereby advantageously increased so that this can also be used as a sweeper or snow-clearing vehicle. Furthermore the maintenance and repair of the mowing machine is advantageously made easier through the de-coupling possibilities.

In an advantageous development the oil tank is mounted at the front in the region of the cutting unit. In a suitable embodiment a corresponding device is provided which supports the cutting unit and the gear unit as well as has a frame coupled to the mowing machine wherein the device provides sufficient installation space for mounting the oil tank. The oil tank is thereby set up inter alia for cooling the oil through convection with the atmospheric air whereby on the one hand the service life of the apparatuses driven by the hydraulic oil is increased and on the other hand the heat stress on the vehicle driver is advantageously reduced.

In a likewise advantageous development a cooling system is provided for cooling the hydraulic oil which flows through the oil circuit during mowing operations. The cooling system is designed by way of example as a separate cooler for the oil tank so that it is ensured that a particularly effective heat dissipation of the oil circuit takes place.

In a further preferred development the cut-grass collecting container of the grass collecting system has a first container region and a second container region wherein the first container region rests at least in part on the back of the tractor, and wherein the second container region of the cut-grass collecting container continues down behind the tractor towards the ground. The cut-grass collecting container is thus essentially a combination of the towed trailer variation already mentioned and the rest-on or mounted semi-trailer variation.

Conventionally the oil tank is mounted for the purpose of balance on the side of the collecting container which lies opposite the turbine. Through the front mounting of the oil tank for better cooling a particularly simple and reliably operating cut-grass collecting container is achieved through the second container region and its continuation towards the ground, which in particular counteracts the mowing machine tipping over. Through the combined design the weight load on the rear axle of the tractor is advantageously reduced compared with a purely semi-trailer variation. To this end it is conceivable in a further possible development to further reduce the load on the rear axle by means of a weight distribution system so that it is ensured that the axle is not overloaded.

In a further suitable development the second container region of the cut-grass collecting container has a wheel axle extending preferably over the entire container width and provided with a number of wheels, preferably two wheels mounted at the sides for resting on the ground. The wheels are designed in particular in the manner of drive-less support wheels or caster wheels. In this further embodiment the weight of the cut-grass collecting container rests at least in part on the wheels so that by way of example any possible problems with the braking system of the tractor are advantageously avoided. By supporting the cut-grass collecting container on the ground the safety aspect is further improved during hydraulic adjustment for the purpose of tipping out the cut grass, particularly when tipping out the grass over a high loading edge of a standby transport vehicle.

In a preferred design the cut-grass collecting container extends substantially over the entire width and/or height of the mowing machine. By restricting the width of the cut-grass collecting container it is ensured that the vehicle driver is able to see the entire rear area of the mowing machine by means of the side mirrors which are fixed on the vehicle so that collisions with objects (trees, banks or the like) can advantageously be avoided.

By restricting the height of the cut-grass collecting container it is ensured that even with a fully loaded cut-grass collecting container the centre of gravity of the vehicle is low enough to prevent the vehicle from tipping over. The mowing machine can thereby be used without problem and safely even in the region where the ground slopes.

The combination according to the invention of the towed trailer variation and the semi-trailer variation thus enables optimization between length, width and height of the cut-grass collecting container with at the same time comparatively large collecting volumes, preferably up to 1300 litres. With the combined supported and towed cut-grass collecting container the mowing machine can thus basically be constructed overall advantageously narrower with an improved stability.

Embodiments of the invention will now be explained below in further detail with reference to the drawings. The drawings show:

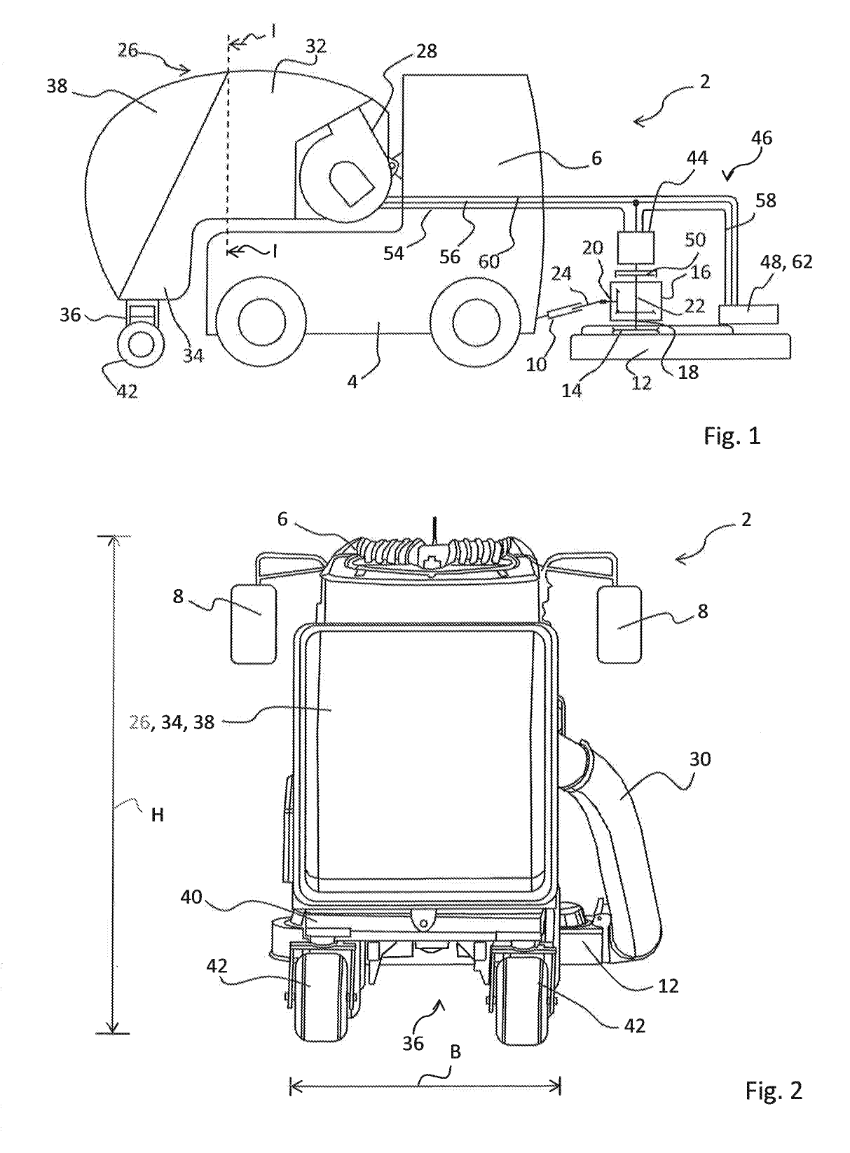

FIG. 1 a side view of a mowing machine with a grass collecting system and with a gear unit as well as with a hydraulic oil circuit with oil pump, and

FIG. 2 shows a rear view of the mowing machine with a cut-grass collecting container and a wheel axle with two support wheels supporting same.

Corresponding parts and sizes are provided with the same reference numerals in all figures.

FIG. 1 shows a self-propelled front mowing machine 2 controlled by a vehicle driver and having a grass collecting system for large grass areas, such as by way of example parks or sports grounds. The mowing machine 2 comprises essentially a tractor 4 driven by an internal combustion engine and having a driver cab 6 at the front and an internal combustion drive motor (not shown) mounted at the back. The driver cab 6 comprises—as shown in FIG. 2—two side mirrors 8 mounted at the sides and with which the vehicle driver can see substantially the entire rear area of the mowing machine 2 in order to avoid collisions with objects (trees, banks or the like). A crankshaft 10 is guided from the internal combustion drive motor to the front end of the mowing machine 2 and projects there as a shaft extension in the manner of a power-take-off shaft coupling.

A cutting unit 12 is coupled to the front of the mowing machine 2. The cutting unit 12 comprises a cutting tool (not shown in further detail), preferably one or more cutting blades or mowing beams. The cutting unit 12 has a drive disc 14 with a mowing belt drive which is coupled to a cube-like gear unit 16 by means of a first gear shaft 18 on the cutting unit side. The gear shaft 18 on the cutting unit side is extended out from the cube-like housing of the gear unit 16 and is coupled by the drive disc 14 to the cutting tool for driving the latter.

The gear shaft 18 on the cutting unit side, a (third) gear shaft 20 on the drive side, and a (second) gear shaft 22 on the pump side project substantially out from the gear unit 16. The gear shafts 18, 20 and 22 are thereby mounted so that these are arranged T-fashion tilted by roughly 90. about the cube-like housing of the gear unit 16.

The (first) gear shaft 18 on the cutting unit side runs substantially vertically along the short T-arm and projects on the ground side out from the gear housing for coupling to the drive disc 14. The (third) gear shaft 20 on the drive side runs substantially horizontally along the long T-arm and projects on the vehicle side out from the gear unit 16. The shaft journal formed thereby and the crankshaft 10 at the front side driven by the internal combustion drive motor are preferably coupled to one another by a universal joint shaft 24. The cutting unit 12 can be driven by means of the internal combustion drive motor of the tractor 4 via the universal joint shaft 24. The (second) gear shaft 22 on the pump side projects along the short T-arm vertically out of the side face of the gear unit 16 which is remote from the ground.

The grass collecting system of the mowing machine 2 has a cut-grass collecting container 26 which is assigned a turbine 28. A flexible duct 30 in the form of a tube leads from the turbine to the cutting unit 12. The cut grass is sucked up from the cutting unit 12 by means of the turbine 28 and transported via the duct 30 into the cut-grass collecting container 26.

The cut-grass collecting container 26 is hydraulically adjustable in order to enable easier emptying by shaking the cut grass into a standby transport vehicle. For this the cut-grass collecting container 26 can be vertically lifted and tilted hydraulically in order to be able to lift the cut-grass collecting container 26 above the loading edge of a standby vehicle and to tip the cut grass out from the cut-grass collecting container 26.

The cut-grass collecting container 26 is designed more particularly as a combination of a towed trailer variation and a semi-trailer variation. The cut-grass collecting container 26 has for this purpose a first container region 32 and a second container region 34 wherein the first container region 32 rests at least in part at the back on the tractor 4. The second container region 34 is continued behind the cut-grass collecting system 2 down to the ground by means of a support unit 36.

In FIG. 1 the division of the cut-grass collecting container 26 into the container regions 32 and 34 is shown by a dotted line I-I. The rear container region 34 has a flap 38 which can be moved into an open position for simply shaking the cut grass out from the essentially closed cut-grass collecting container 26.

The container region 34 of the cut-grass collecting container 26 on the vehicle side clings substantially to the contour of the mowing machine 2. The support unit 36 comprises a wheel axle 40 which extends over the entire container width B and has two side-mounted support wheels 42.

The turbine 28 is hydraulically operated. To this end hydraulic oil is moved by means of a pump 44 in an oil circuit 46 in which an oil tank 48 is mounted. The pump 44 is more particularly a reciprocating hydraulic pump which is coupled by a coupling 50 to the (second) gear shaft 22 on the pump side. The pump 44 is for this purpose mounted substantially vertically above the gear unit 16 wherein the lift movement of the reciprocating piston takes place substantially vertically to the gear unit 16 in the direction of the short T-arm. The pump 44 can thereby be operated together with the cutting unit 12 by the tractor 4, i.e. its drive motor. The coupling 50 serves to de-couple the pump 44 from the gear shaft 22 and thus from the gear unit 16. Maintenance and/or repair of the pump 44 is thereby advantageously much easier.

The oil circuit 46 comprises essentially a hydraulic line 54 as the lead to a hydraulic motor (not shown in further detail) of the turbine 28, a oil leakage line 56 between the hydraulic motor, the pump 44 and the oil tank 48, as well as a suction line 58 between the pump 44 and the oil tank 48, as well as a return line 60 between the hydraulic motor and the oil tank 48.

The oil tank 48 is mounted at the front, i.e. on the front side of the vehicle 2 in the region of the cutting unit 12. The oil tank 48 serves inter alia for cooling the hydraulic oil during operation through convection, wherein for this purpose a separate cooler 62 is provided as an addition or as an alternative.

In a suitable dimensioning the container width B of the cut-grass collecting container 26 does not extend beyond the width of the mowing machine 2. It is thereby ensured that the vehicle driver can see via the side mirrors 8 the entire rear region of the mowing machine 2. The height H of the mowing machine 2 and in particular of the cut-grass collecting container 26 is selected so that even with a fully loaded cut-grass collecting container 26 the centre of gravity of the mowing machine 2 lies low enough so that it is ensured that the mowing machine 2 does not tip over, even in the region where the ground slopes.

In a preferred dimensioning the length, width and height of the cut-grass collecting container 26 are selected so that a comparatively large collecting volume of about 1300 litres is achieved. The mowing vehicle 2 has the maximum width extension of about 1.7 metres in the region of the cutting unit 12.

The invention is not restricted to the embodiments described above. Rather other variations of the invention can also be derived therefrom by the technical expert without departing from the subject of the invention. More particularly all individual features described in connection with the different embodiments can also be combined with one another in different ways without departing from the subject of the invention.

LIST OF REFERENCE NUMERALS

| | |
|---|---|
| 2 | Mowing machine |
| 4 | Tractor |
| 6 | Driver cab |
| 8 | Side mirrors |
| 10 | Crankshaft |
| 12 | Cutting unit |
| 14 | Drive disc |
| 16 | Gear unit |
| 18 | Gear shaft |
| 20 | Gear shaft |
| 22 | Gear shaft |
| 24 | Universal shaft joint |
| 26 | Cut-grass collecting container |
| 28 | Turbine |
| 30 | Duct |
| 32 | Container region |
| 34 | Container region |
| 36 | Support unit |
| 38 | Flap |
| 40 | Wheel axle |
| 42 | Support wheel |
| 44 | Pump |
| 46 | Oil circuit |
| 48 | Oil tank |
| 50 | Coupling |
| 54 | Hydraulic line |
| 56 | Oil leakage line |
| 58 | Suction line |
| 60 | Return line |
| 62 | Cooler |
| B | Container width |
| H | Vehicle height |

1-10. (canceled)

11. A mowing machine, comprising:
a tractor driven by an internal combustion engine;
a gear unit for coupling to said tractor by way of a drive shaft, said gear unit having a first gear shaft configured for driving a cutting unit to be mounted at front of the mowing machine;
a grass collecting system including a cut-grass collecting container mounted at a rear of the mowing machine, said cut-grass collecting container being mounted for lifting and tilting, and said grass collecting system including a turbine for aspirating cut grass from the cutting unit and for conveying the cut grass into the cut-grass collecting container;
a hydraulic oil supply device for driving said turbine connected in an oil circuit having an oil tank; and
a second gear shaft coupling said oil supply device to said gear unit driven by said tractor.

12. The mowing machine according to claim 11, wherein said gear unit has a substantially cube-like gear housing.

13. The mowing machine according to claim 11, wherein said gear unit is enclosed in a gear housing and wherein at least one of said first gear shaft serving to drive the cutting unit, said second gear shaft serving to drive said oil supply device, or a third gear shaft to be coupled to said drive shaft projects at least in part out from said gear housing.

14. The mowing machine according to claim 11, which comprises a clutch coupling said oil supply device to said second gear shaft.

15. The mowing machine according to claim 11, wherein said oil supply device is mounted substantially vertically above said gear unit.

16. The mowing machine according to claim 11, wherein said oil tank is mounted at the front of the mowing machine in a region of the cutting unit.

17. The mowing machine according to claim 11, which further comprises a cooling system for cooling an hydraulic oil flowing through said oil circuit during a mowing operation.

18. The mowing machine according to claim 11, wherein said cut-grass collecting container comprises a first container region and a second container region, wherein said first container region rests at least in part on said tractor and said second container region is continued downward towards the ground along a back of said tractor.

19. The mowing machine according to claim 18, wherein said second container region is provided with a wheel axle supporting at least one wheel.

20. The mowing machine according to claim 19, wherein said wheel axle supports two wheels respectively arranged at the sides for support on the ground.

21. The mowing machine according to claim 11, wherein said cut-grass collecting container extends substantially over an entire width and/or height of the mowing machine.
